(19) United States
(12) Patent Application Publication
(10) Pub. No.: US 2013/0064195 A1
(43) Pub. Date: Mar. 14, 2013

(54) Method of Handling Random Access Procedure on Secondary Cell when Primary Cell Time Alignment Timer Expires

(71) Applicant: Po-Yu Chang, Taoyuan County (TW)

(72) Inventor: Po-Yu Chang, Taoyuan County (TW)

(21) Appl. No.: 13/605,971

(22) Filed: Sep. 6, 2012

Related U.S. Application Data
(60) Provisional application No. 61/532,116, filed on Sep. 8, 2011.

(51) Int. Cl. H04W 74/08

(52) U.S. Cl. 370/329

(57) ABSTRACT

A method of handling a random access procedure for a mobile device in a wireless communication system is disclosed. The method comprises having an ongoing random access procedure on a secondary cell; and aborting the ongoing random access procedure on the secondary cell when a time alignment timer associated with a primary cell expires.

### CROSS REFERENCE TO RELATED APPLICATIONS

This application claims the benefit of U.S. Provisional Application No. 61/532,116, filed on Sep. 08, 2011 and entitled “Method for Handling Random Access Channel Procedure on a SCell When PCell TA Timer Expires”, the contents of which are incorporated herein in their entirety.

### BACKGROUND OF THE INVENTION

1. Field of the Invention

The application relates to a method in a wireless communication system and related communication device, and more particularly, to a method of handling a random access procedure on a secondary cell when a primary cell time alignment timer expires for a mobile device in a wireless communication system.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, a radio access network known as an evolved universal terrestrial radio access network (E-UTRAN) includes a plurality of evolved Node-Bs (eNBs) for communicating with a plurality of user equipments (UEs) and communicates with a core network including a mobility management entity (MME), serving gateway, etc for NAS (Non Access Stratum) control.

A long term evolution-advanced (LTE-A) system, as its name implies, is an evolution of the LTE system, considering relaying for cost-effective throughput enhancement and coverage extension. For example, a relay can be deployed at the cell edge where the eNB is unable to provide required radio quality/throughput for the UEs or at certain location where radio signals of the eNB cannot cover. The LTE-A system can support a wider bandwidth up to 100 MHz to satisfy requirement for peak data rate. Carrier aggregation (CA) where two or more component carriers are aggregated is employed for the LTE-A system to achieve wider-band transmission. An LTE-A specification supports carrier aggregation for both continuous and non-continuous component carrier (CC) with each component carrier limited to a maximum of 110 resource blocks. The carrier aggregation increases spectrum flexibility by aggregating the component carriers in the different frequency band (non-continuous spectrum).

When CA is configured, the UE only has one RRC connection with the network. At RRC connection establishment/re-establishment, one serving cell provides the security input (one ECGI, one PCI and one ARFCN) and the NAS mobility information (e.g. TAI) similarly as in Rel-8/9 under 3GPP. This cell is referred to as the Primary Cell (PCell). Depending on UE capabilities, Secondary Cells (SCells) can be configured to form together with the PCell a set of serving cells. The configured set of serving cells for a UE therefore always consists of one PCell and one or more SCells.

In the LTE system, if a mobile device such as a mobile phone desires to connect to the Internet or communicate with other mobile phones via the LTE system, the mobile device firstly needs to be synchronized with a base station that serves the mobile device on uplink (UL) timing. The purpose of being synchronized with the base station is to prevent signals transmitted from the mobile device from colliding with other signals sent from other mobile devices under the coverage of the base station. In general, a time alignment timer of the mobile device is utilized for indicating whether the mobile device is synchronized with the base station on uplink timing. When the time alignment timer is running, uplink timing synchronization is still established. If the time alignment timer expires, then this indicates that the mobile device is not synchronized with the base station on uplink timing.

A user equipment (UE) shall not perform any uplink transmission except the Random Access Preamble transmission if its uplink transmission timing is unsynchronized. A Random Access procedure is used to achieve uplink time synchronization for a UE which either has not yet acquired or has lost its uplink synchronization. The random access procedure comes in two forms, contention-based and contention free (a.k.a. non-contention-based). In a contention-based random access procedure, a random access preamble signature is randomly chosen by the UE, with the result that it is possible for more than one UE simultaneously to transmit the same signature, leading to a need for a subsequent contention resolution process. Contention Resolution is based on either C-RNTI on PDCCH of the PCell or UE's Contention Resolution Identity on a downlink share channel (DL-SCH). For the contention free random access procedure, the eNodeB has the option of preventing contention from occurring by allocating a dedicated signature to a UE, resulting in contention free access.

FIG. 1A and 1B are diagrams showing a random access procedure in the prior art. As seen in FIG. 1A, three steps of a non-contention-based random access procedure are: a random access preamble assignment via dedicated signaling in downlink; a random access preamble transmission on random access channel in uplink; and a random access response on downlink shared channel (DL-SCH). When performing non-contention based random access on the PCell while CA is configured, preamble transmission on PRACH and reception of a PDCCH order occur on the PCell. When performing non-contention based random access on the SCell while CA is configured, preamble transmission on PRACH occur on the indicated SCell and reception of a PDCCH order takes place on the scheduling cell of this SCell. The E-UTRAN needs to transmit a random access response (RAR) corresponding to the random access preamble to the UE. A MAC RAR usually consists of three fields: Timing Advance Command/UL Grant/Temporary C-RNTI. In FIG. 1B, the four steps of the contention based random access procedures are: a random access preamble transmission on RACH in uplink; a random access response generated by the eNB on DL-SCH; a first scheduled uplink transmission on uplink shared channel (UL-SCH); and Contention Resolution on downlink.

The UE has a configurable timer, called time alignment timer, per timing advance group (which is a group of serving cells configured by RRC using the same timing reference cell and timing advance value). A timing advance group containing PCell is a primary timing advance group. The time alignment timer is used to control how long the UE considers the serving cells belonging to the associated timing advance Group to be uplink time aligned. When a timing advance command is received, the UE applies the timing advance command for an indicated timing advance group and the UE starts or restarts a time alignment timer associated with the indicated timing advance Group. It is possible that, when the time alignment timer of PCell expires, the random access procedure on a SCell is still ongoing. That means even the random access procedure on a SCell is completed successfully, the time alignment timer associated with the SCell is still considered expired, i.e. the SCell is still considered not uplink-synchronized. Therefore, performing such random access has no benefits and consumes power. It is also possible that the UE may receive a PDCCH order for triggering random access procedure on a SCell under the condition that the time alignment timer associated with PCell expires or has expired.

### SUMMARY OF THE INVENTION

A method of handling a random access procedure for a mobile device in a wireless communication system is disclosed. The method comprises having an ongoing random access procedure on a secondary cell; and aborting the ongoing random access procedure on the secondary cell when a time alignment timer associated with a primary cell expires.

A method of handling random access procedure for a mobile device in a wireless communication system is disclosed. The method comprises receiving a physical downlink control channel (PDCCH) order for triggering a random access procedure on a secondary cell; and not initiating the random access procedure on the secondary cell when a time alignment timer associated with a primary cell expires.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram showing a non-contention-based random access procedure according to the prior art.

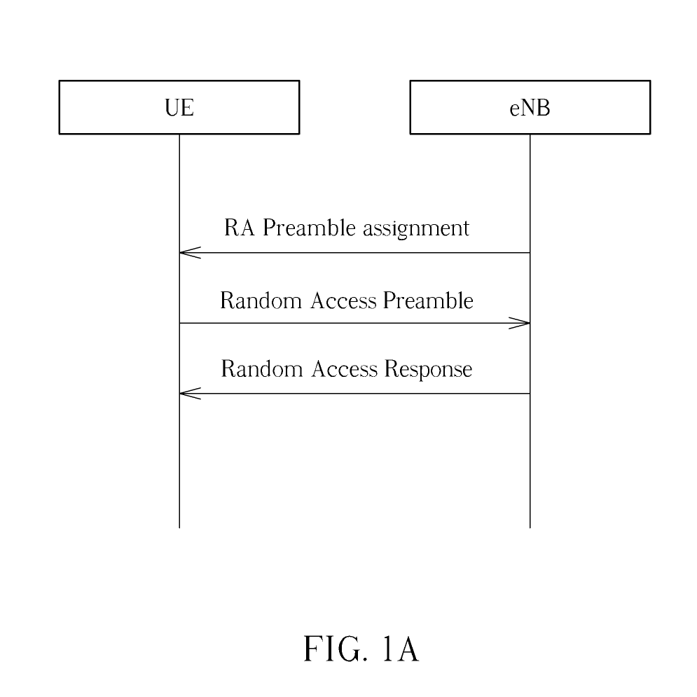

FIG. 1B is a diagram showing a contention-based random access procedure according to the prior art.

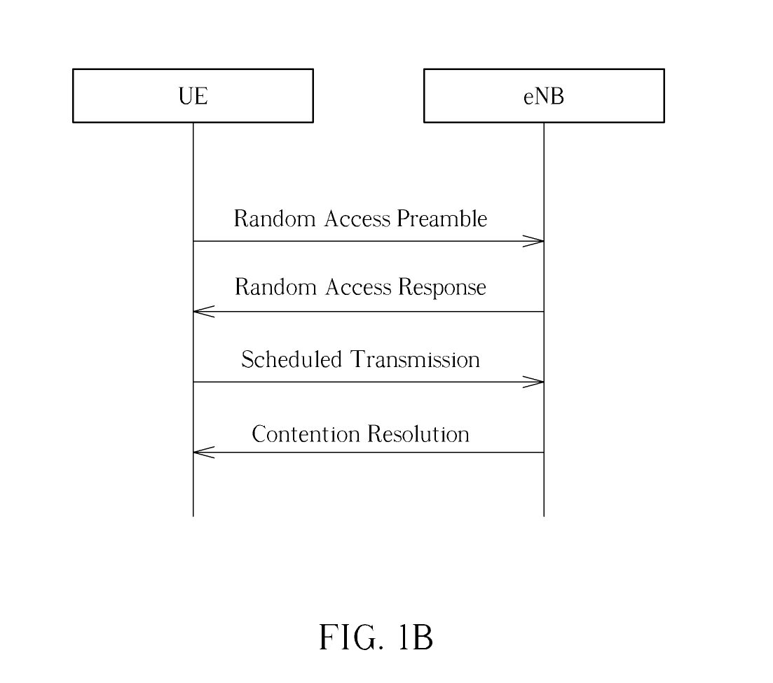

FIG. 2 is a schematic diagram of an exemplary wireless communication system.

FIG. 3 is a schematic diagram of an exemplary communication device.

FIG. 4 is a flow chart of an exemplary process.

FIG. 5 is a flow chart of an exemplary process.

### DETAILED DESCRIPTION

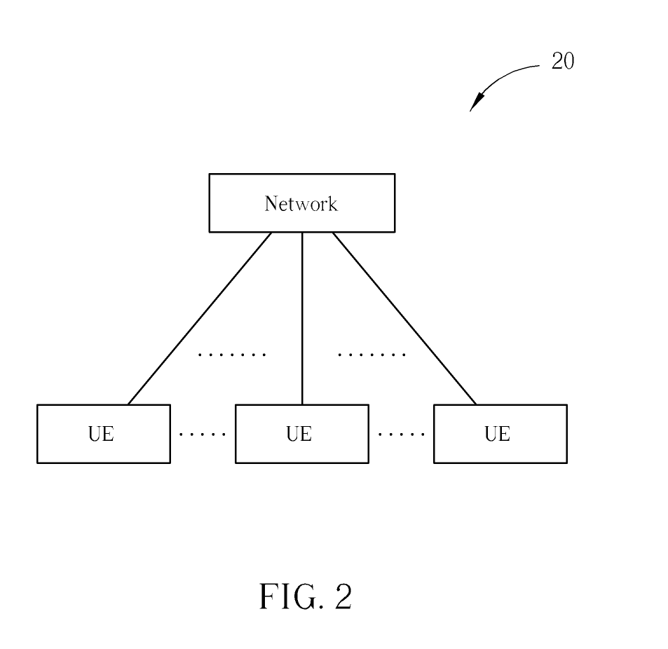

Please refer to FIG. 2. FIG. 2 is a schematic diagram of an exemplary wireless communication system 20. The wireless communication system 20 can be an LTE-Advanced system, or other mobile communication systems. The wireless communication system 20 is briefly composed of a network and a plurality of user equipments (UEs), as the structure illustrated in FIG. 2. To achieve bandwidth extension, the wireless communication system 20 supports carrier aggregation (CA), where two or more component carriers (CCs) are aggregated. In the CA arrangement, a single UE may be assigned radio resources on more than one CC. In some cases more than one uplink CC is aligned in time and so the same time alignment timer can be used for them all . In other cases at least two of the uplink CCs assigned to the UE are timing-independent so that the UE must maintain a separate time alignment timer for each of different timing advance groups it is assigned to. A timing advance group is a group of serving cells configured by RRC using the same timing reference cell and Timing Advance value. In the LTE-Advanced system, the network is referred as an evolved universal terrestrial radio access network (E-UTRAN) comprising a plurality of evolved base stations (eNBs). The UEs can be devices such as mobile phones, computer systems, etc. Besides, the network and the UE can be seen as a transmitter or receiver according to transmission direction, e.g., for uplink (UL), the UE is the transmitter and the network is the receiver, and for downlink (DL), the network is the transmitter and the UE is the receiver.

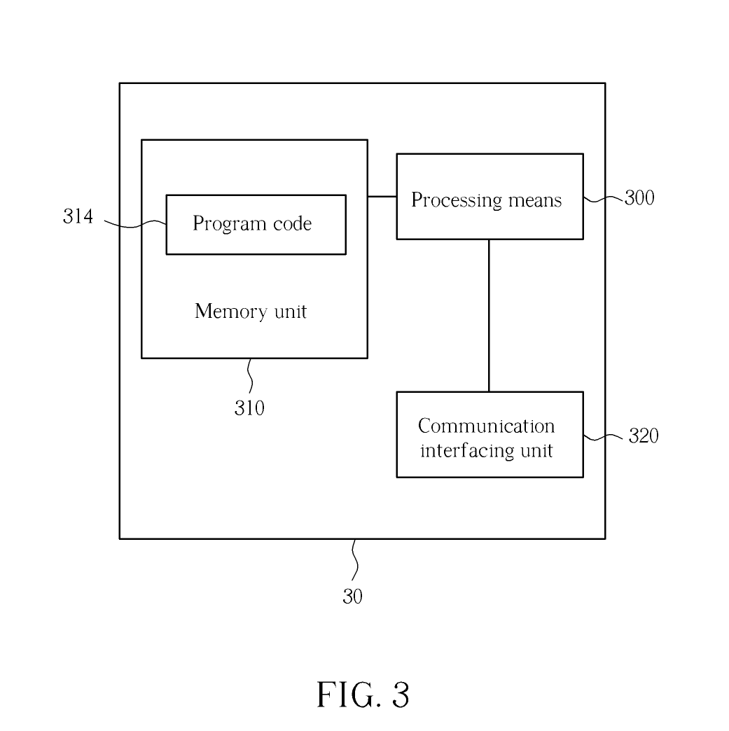

Please refer to FIG. 3. FIG. 3 is a schematic diagram of an exemplary communication device 30. The communication device 30 can be the UE or the network shown in FIG. 2 and may include a processing means 300 such as a microprocessor or ASIC, a memory unit 310, and a communication interfacing unit 320. The memory unit 310 may be any data storage device that can store program code 314 for access by the processing means 300. Examples of the memory unit 310 include but are not limited to a subscriber identity module (SIM), read-only memory (ROM), random-access memory (RAM), CD-ROMs, magnetic tapes, floppy disks, and optical data storage devices. The communication interfacing unit 320 is preferably a radio transceiver for wirelessly communicating with the network according to processing results of the processing means 300.

The configured set of serving cells for a UE therefore always consists of one Primary Cell (PCell) and one or more Secondary Cells (SCells). The UE may include multiple timing advance groups. The number of time alignment timers for a UE is equal to the number of timing advance groups for this UE in the CA system.

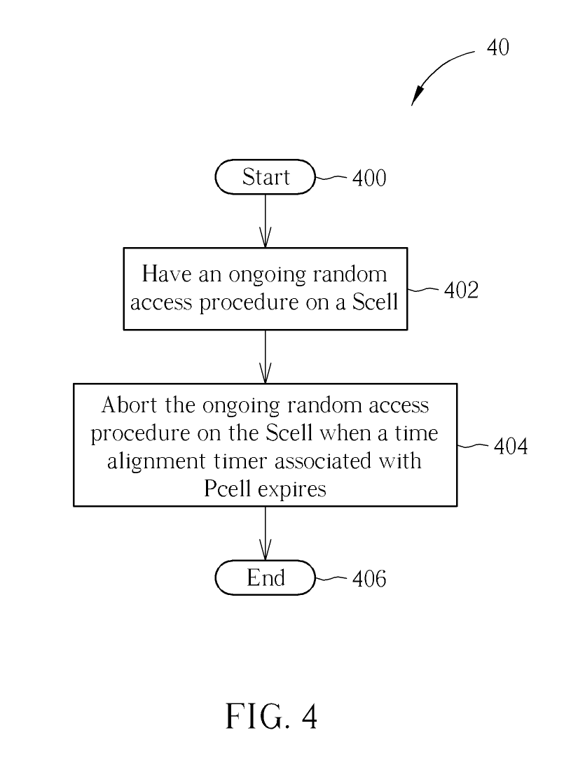

Please refer to FIG. 4, which is a flow chart of an exemplary process 40. The process 40 is used for a random access procedure for a UE in a wireless communication system. The wireless communication system could be the wireless communication system 20. The process 40 can be compiled into the program code 314 and includes the following steps:

Step 400: Start.

Step 402: Have an ongoing random access procedure on a SCell.

Step 404: Abort the ongoing random access procedure on the SCell when a time alignment timer associated with a PCell expires.

Step 406: End.

According to the process 40, the UE has the ongoing random access procedure on the SCell. The UE aborts the ongoing random access procedure on the SCell when the time alignment timer associated with the PCell expires. This prevents the UE from finishing the ongoing random access procedure on the SCell when the time alignment timer associated with the PCell expires to save more UE batteries, since finishing the ongoing random access procedure has no benefits at that situation. In other words, when the UE still has a random access procedure ongoing on the SCell when the time alignment timer associated with PCell expires, the UE can abort the ongoing random access procedure on the SCell.

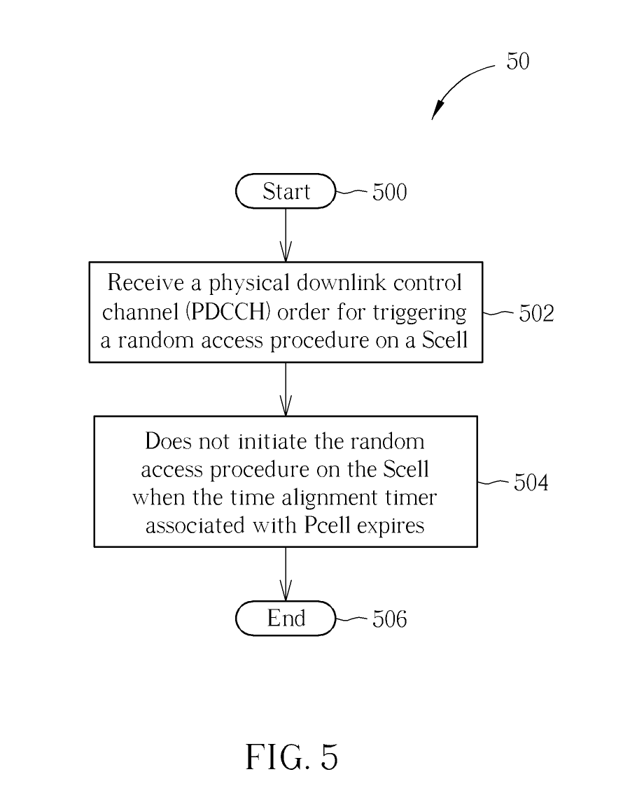

Please refer to FIG. 5, which is a flow chart of an exemplary process 50. The process 50 is used for a random access procedure for a UE in a wireless communication system. The wireless communication system could be the wireless communication system 20. The process 50 can be compiled into the program code 314 and includes the following steps:

Step 500: Start.

Step 502: Receive a physical downlink control channel (PDCCH) order for triggering a random access procedure on a SCell

Step 504: Do not initiate the random access procedure on the SCell when the time alignment timer associated with a PCell expires.

Step 506: End.

According to the process 50, the UE receives the PDCCH order for triggering the random access procedure on the SCell, and the UE does not initiate the random access procedure on the SCell when the time alignment timer associated with the PCell expires. In some examples, the UE ignores the PDCCH order (e.g. UE drops a dedicated preamble assigned from eNB) for triggering the random access procedure on the SCell. In other examples, the UE delays the random access procedure on the SCell until synchronization on the PCell is recovered. Furthermore, when the synchronization on the PCell has been recovered and if a dedicated preamble (which is assigned from eNB) on the SCell becomes invalid due to that a timer expires, the UE does not initiate the random access procedure on the SCell then the UE may drop the invalid preamble. In this example, a timer is used for counting a valid period of the dedicated preamble and the timer starts when the dedicated preamble is received on the SCell.

Please note that, in the process 40 and the process 50, the ongoing random access procedure can be a contention-based random access procedure or contention-free random access procedure.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the UE aborts the ongoing random access procedure on the SCell when the time alignment timer associated with PCell expires. In another example, the UE does not initiate the random access procedure triggered by a received PDCCH order on the Scell when the time alignment timer associated with the PCell expires. Therefore, the UE does not need to finish meaningless random access procedure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a random access procedure for a mobile device in a wireless communication system, the method comprising:
having an ongoing random access procedure on a secondary cell; and
aborting the ongoing random access procedure on the secondary cell when a time alignment timer associated with a primary cell expires.

2. A method of handling a random access procedure for a mobile device in a wireless communication system, the method comprising:
receiving a physical downlink control channel (PDCCH) order for triggering a random access procedure on a secondary cell; and
not initiating the random access procedure on the secondary cell when a time alignment timer associated with a primary cell expires.

3. The method of claim 2 further comprising ignoring the PDCCH order for triggering the random access procedure on the secondary cell when the time alignment timer associated with the primary cell expires.

4. The method of claim 2 further comprising delaying the random access procedure on the secondary cell until synchronization on the primary cell is recovered.

5. The method of claim 4, further comprising:
when synchronization on the primary cell has been recovered and a dedicated preamble assigned from a network of the wireless communication system on the secondary cell becomes invalid, not initiating the random access procedure on the secondary cell.

6. The method of claim 5, wherein the dedicated preamble on the secondary cell becomes invalid when a timer which counts a valid period of the dedicated preamble expires.

7. The method of claim 5, further comprising:
dropping the invalid dedicated preamble when deciding not to initiate the random access procedure on the secondary cell.
